(19) United States
(12) Patent Application Publication
(10) Pub. No.: US 2023/0046746 A1
(43) Pub. Date: Feb. 16, 2023

(54) INFORMATION PROCESSING DEVICE AND INFORMATION PROCESSING METHOD

(71) Applicant: SONY GROUP CORPORATION, TOKYO (JP)

(72) Inventors: YUSUKE SAKAI, TOKYO (JP); MASANORI SETO, KOCHI (JP)

(21) Appl. No.: 17/759,618

(22) PCT Filed: Jan. 21, 2021
(86) PCT No.: PCT/JP2021/001948

§ 371 Date: Jul. 27, 2022

(30) Foreign Application Priority Data
Feb. 4, 2020 (JP) 2020-016808

(51) Int. Cl. H04N 7/15; H04N 5/272; G06F 3/01; G06F 3/16

(52) U.S. Cl. CPC H04N 7/152; H04N 5/272; G06F 3/011; G06F 3/016; G06F 3/16

(57) ABSTRACT

The present technology relates to an information processing device and an information processing method, which are capable of allowing users at remote locations to each grasp more deeply the condition of the space where the partner is present. Provided is an information processing device including a control unit, wherein, between a first space where a first imaging device and a first display device are installed and a second space where a second imaging device and a second display device are installed, when a captured image captured by the imaging device in one of the spaces is displayed by the display device in the other space in real time, the control unit performs a control for presenting a state of the second space in an ineffective region excluding an effective region in which a captured image captured by the second imaging device is displayed, in a display region of the first display device. The present technology can be applied to, for example, a video communication system.

### TECHNICAL FIELD

The present technology relates to an information processing device and an information processing method, and more particularly, to an information processing device and an information processing method which are capable of allowing users at remote locations to each grasp more deeply the condition of the space where the partner is present.

### BACKGROUND ART

In the related art, users at remote locations can talk while viewing each other's faces with video communication systems, and thus more familiar communication can be achieved.

As a technology related to video communication systems, for example, a technology disclosed in PTL 1 is known. In PTL 1, a user being present in one space can point to any desired position for a user being present in the other space in order to communicate with each other.

### CITATION LIST

### Patent Literature

[PTL 1]

JP 2012-79167 A

### SUMMARY

### Technical Problem

Incidentally, when users in remote locations use a video communication system, it is required that each of the users grasps more deeply the condition of the space of the partner.

The present technology has been made in view of such a situation, and makes it possible to allow users at remote locations to each grasp more deeply the condition of the space of the partner.

### Solution to Problem

An information processing device according to an aspect of the present technology is an information processing device including a control unit, wherein, between a first space where a first imaging device and a first display device are installed and a second space where a second imaging device and a second display device are installed, when a captured image captured by the imaging device in one of the spaces is displayed by the display device in the other space in real time, the control unit performs a control for presenting a state of the second space in an ineffective region excluding an effective region in which a captured image captured by the second imaging device is displayed, in a display region of the first display device.

An information processing method according to an aspect of the present technology is an information processing method of causing an information processing device to perform: between a first space where a first imaging device and a first display device are installed and a second space where a second imaging device and a second display device are installed, when a captured image captured by the imaging device in one of the spaces is displayed by the display device in the other space in real time, a control for presenting a state of the second space in an ineffective region excluding an effective region in which a captured image captured by the second imaging device is displayed, in a display region of the first display device.

In the information processing device and the information processing method according to aspects of the present technology, between a first space where a first imaging device and a first display device are installed and a second space where a second imaging device and a second display device are installed, when a captured image captured by the imaging device in one of the spaces is displayed by the display device in the other space in real time, a state of the second space is presented in an ineffective region excluding an effective region in which a captured image captured by the second imaging device is displayed, in a display region of the first display device.

The information processing device according to still another aspect of the present technology may be an independent device or may be an internal block in which one device is configured.

### BRIEF DESCRIPTION OF DRAWINGS

FIG. 1 is a diagram illustrating a configuration example of an embodiment of an information processing system to which the present technology is applied.

FIG. 2 is a diagram illustrating a configuration example of an information processing device illustrated in FIG. 1.

FIG. 3 is a diagram illustrating a functional configuration example of a control unit of the information processing device illustrated in FIG. 1.

FIG. 4 is a diagram illustrating an outline of a change in the shape of an effective region in a display region of the information processing device illustrated in FIG. 1.

FIG. 5 is a diagram illustrating a first example of the shapes of an effective region and an ineffective region in the display region.

FIG. 6 is a diagram illustrating a second example of the shapes of an effective region and an ineffective region in the display region.

FIG. 7 is a diagram illustrating a third example of the shapes of an effective region and an ineffective region in the display region.

FIG. 8 is a diagram illustrating an example of human visual field characteristics.

FIG. 9 is a diagram illustrating an example of a dialogue in the situation where users face each other.

FIG. 10 is a diagram illustrating an example of a dialogue in the situation where users are side by side.

FIG. 11 is a diagram illustrating a relationship between a discrimination visual field, an effective visual field, and a stable visual fixation field.

FIG. 12 is a diagram illustrating the relationship between a region corresponding to the visual field characteristics including a discrimination visual field, an effective visual field, and a stable visual fixation field, and a display region having a rectangular or circular shape.

FIG. 13 is a diagram illustrating a first example of presenting a state of a partner space by using an ineffective region.

FIG. 14 is a diagram illustrating a first example of presenting a state of the partner space by using the ineffective region.

FIG. 15 is a diagram illustrating a second example of presenting a state of a partner space using an ineffective region.

FIG. 16 is a diagram illustrating a second example of presenting a state of the partner space using the ineffective region.

FIG. 17 is a diagram illustrating a third example of presenting a state of a partner space using an ineffective region.

FIG. 18 is a diagram illustrating a third example of presenting a state of the partner space using the ineffective region.

FIG. 19 is a diagram illustrating a fourth example of presenting a state of a partner space using an ineffective region.

FIG. 20 is a diagram illustrating a fifth example of presenting a state of a partner space using an ineffective region.

FIG. 21 is a flowchart for describing a flow of processing performed between the devices.

FIG. 22 is a flowchart for describing a flow of display region shape control processing.

FIG. 23 is a flowchart for describing a flow of partner space state presentation control processing.

FIG. 24 is a diagram illustrating another configuration example of an embodiment of an information processing system to which the present technology is applied.

FIG. 25 is a diagram illustrating still another configuration example of an embodiment of an information processing system to which the present technology is applied.

### DESCRIPTION OF EMBODIMENTS

Hereinafter, embodiments of the present technology will be described with reference to the drawings. The description will be made in the following order.

1. Embodiments of Present Technology

2. Modification Examples

3. Configuration of Computer

### 1. EMBODIMENTS OF PRESENT TECHNOLOGY

### System Configuration

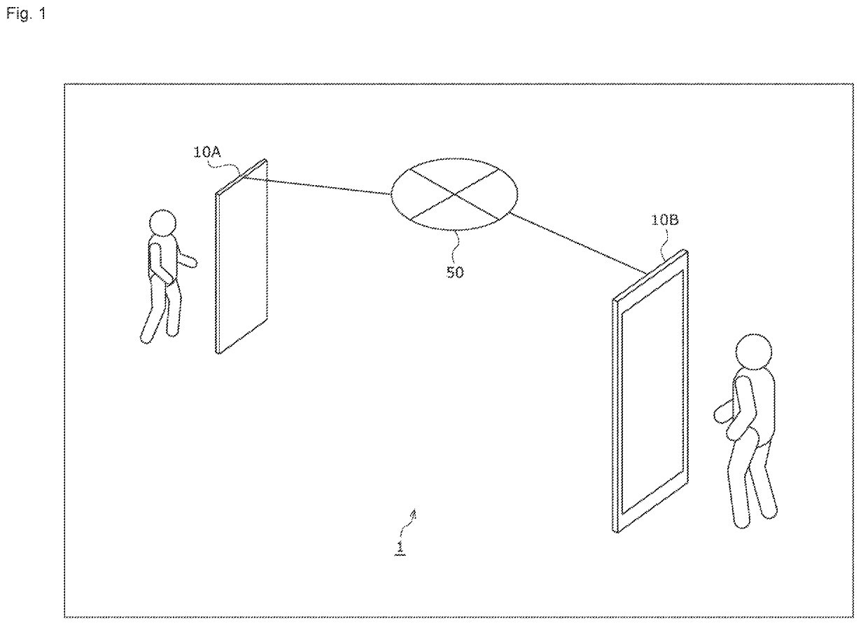

FIG. 1 is a block diagram illustrating a configuration example of an embodiment of an information processing system to which the present technology is applied.

In FIG. 1, the information processing system 1 is configured of two information processing devices 10A and 10B, each serving as a telepresence device, which are connected to a network 50 such as the Internet.

The information processing devices 10A and 10B are provided in different spaces such as different buildings or different rooms. Accordingly, in FIG. 1, a user in the vicinity of the information processing device 10A and a user in the vicinity of the information processing device 10B are users who are at remote locations.

The information processing devices 10A and 10B basically have the same configuration. As will be described below in detail, in the information processing devices 10A and 10B, cameras that capture images of surrounding aspects, microphones that collect surrounding sounds such as environmental sounds, speakers that output sounds, and the like are provided in addition to displays that have large sizes.

Between the information processing devices 10A and 10B, data, such as videos corresponding to captured images captured by their cameras, and sounds collected by their microphones, is transmitted and received, for example, regularly in real time while connection of both sides is established.

The information processing device 10A displays a video corresponding to the captured images captured by the information processing device 10B, and also outputs the sounds collected by the information processing device 10B.

In the video corresponding to the captured images captured by the information processing device 10B, the state of the space where the information processing device 10B is installed appears including the figure of the user in the vicinity of the information processing device 10B. Further, the sounds collected by the information processing device 10B include environmental sounds in the space where the information processing device 10B is installed, including the voice of the user in the vicinity of the information processing device 10B.

Thus, for example, the user in the vicinity of the information processing device 10A can feel as if the user in the vicinity of the information processing device 10B is present in opposite to, that is, on the opposite side of, the information processing device 10A located nearby.

Similarly, the information processing device 10B displays a video corresponding to the captured images captured by the information processing device 10A, and also outputs the sounds collected by the information processing device 10A.

In the video corresponding to the captured images captured by the information processing device 10A, the state of the space where the information processing device 10A is installed appears including the figure of the user in the vicinity of the information processing device 10A. Further, the sounds collected by the information processing device 10A include environmental sounds in the space where the information processing device 10A is installed, including the voice of the user in the vicinity of the information processing device 10A.

Thus, for example, the user of the information processing device 10B can feel as if the user of the information processing device 10A is present in opposite to, that is, on the opposite side of, the information processing device 10B located nearby.

The user of the information processing device 10A can achieve natural communication with the user of the information processing device 10B as if the user of the information processing device 10B is present in an adjacent space.

Similarly, the user of the information processing device 10B can achieve natural communication with the user of the information processing device 10A as if the user of the information processing device 10A is present in an adjacent space.

In other words, the users of the information processing devices 10A and 10B can achieve smoother communication while feeling close to each other by communicating without active awareness.

Hereinafter, when it is not necessary to distinguish between the information processing devices 10A and 10B, they are collectively referred to as the information processing device 10 as appropriate. The same applies to other components provided in pairs.

Further, in the following description, of the information processing devices 10A and 10B, the user using one information processing device 10 of interest is simply referred to as a user, while the user using the other information processing device 10 at a remote location is referred to as a remote user to distinguish between the users. Furthermore, the space where the information processing device 10A is installed is also referred to as a space at point A, and the space where the information processing device 10B is installed is also referred to as a space at point B.

### Device Configuration

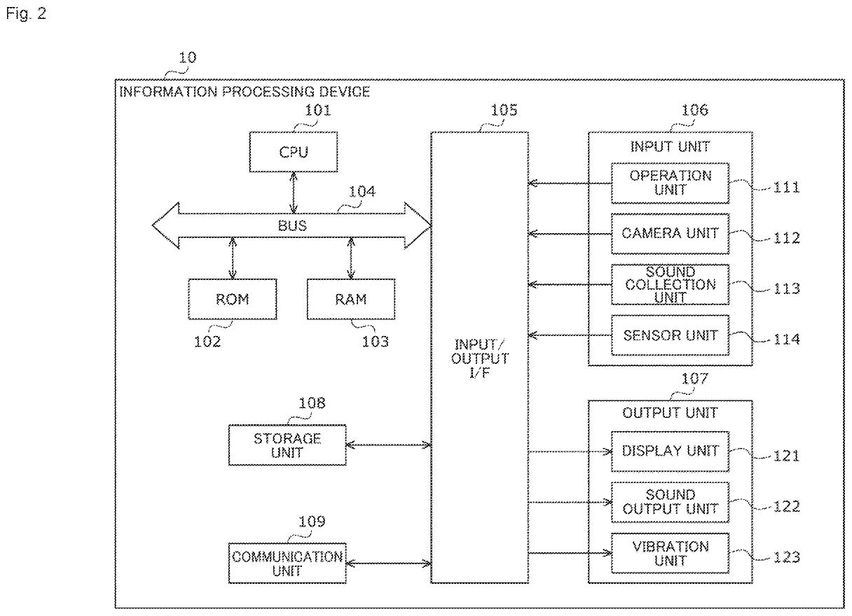

FIG. 2 illustrates a configuration example of the information processing device 10 illustrated in FIG. 1.

The information processing device 10 is, for example, a device such as a display device that is connected to the network 50 such as the Internet, and is configured as a telepresence device.

As illustrated in FIG. 2, in the information processing device 10, a central processing unit (CPU) 101, a read-only memory (ROM) 102, and a random access memory (RAM) 103 are connected to each other via a bus 104.

The CPU 101 controls the operation of each unit of the information processing device 10 by executing a program recorded in the ROM 102 or a storage unit 108. Various types of data are stored in the RAM 103 as appropriate.

An input/output I/F 105 is also connected to the bus 104. An input unit 106, an output unit 107, the storage unit 108, and a communication unit 109 are connected to the input/output I/F 105.

The input unit 106 supplies various types of input data to the units including the CPU 101 via the input/output I/F 105. For example, the input unit 106 includes an operation unit 111, a camera unit 112, a sound collection unit 113, and a sensor unit 114.

The operation unit 111 is operated by the user, and supplies operation data corresponding to the user operation to the CPU 101. The operation unit 111 is composed of physical buttons, a touch panel, and the like.

The camera unit 112 performs photoelectric conversion on the light incident thereon from the subject and performs signal processing on the resulting electric signal to generate and output captured image data. The camera unit 112 is composed of an image sensor, a signal processing unit, and the like.

The sound collection unit 113 receives sound as a vibration of air and outputs the resulting electric signal as sound information data. The sound collection unit 113 is composed of a microphone and the like.

The sensor unit 114 senses spatial information, time information, and the like, and outputs the result of sensing as sensor data.

The sensor unit 114 includes an acceleration sensor, a gyro sensor, and the like. The acceleration sensor measures accelerations in three directions on XYZ axes. The gyro sensor measures angular velocities with respect to the three XYZ axes. Alternatively, an inertial measurement unit (IMU) may be provided to measure three-dimensional acceleration and angular velocity with a three-directional accelerometer and a three-axis gyroscope.

The sensor unit 114 may also include various types of sensors such as a biological sensor for measuring information including the heart rate, body temperature, or posture of a living body, a proximity sensor for measuring a proximity object, and a magnetic sensor for measuring the magnitude and direction of a magnetic field.

The output unit 107 outputs various types of information according to the control from the CPU 101 via the input/output I/F 105. For example, the output unit 107 includes a display unit 121, a sound output unit 122, and a vibration unit 123.

The display unit 121 displays a video or the like corresponding to the captured image data according to the control from the CPU 101. The display unit 121 is composed of a panel unit such as a liquid crystal panel, an OLED (Organic Light Emitting Diode) panel, or the like, and a signal processing unit. Alternatively, the display unit 121 may be a projector. The projector makes it possible to project and display a video corresponding to the captured image data on any screen.

In the following description, in a display region (display surface) of the panel unit of the display unit 121, a region in which a captured image (video) of a space where the partner user is at a remote location (a space of the partner, which is the connection destination) is referred to as an effective region, and the region excluding the effective region is referred to as an ineffective region. It can also be said that the ineffective region is a mask region, which is masked.

The vibration unit 123 vibrates the ineffective region (display surface) in the display region of the display unit 121 according to the control from the CPU 101. The vibration unit 123 is composed of, for example, a vibration mechanism having a motor, a piezoelectric element, or the like.

Note that the display unit 121 and the vibration unit 123 may be integrally configured. Further, in the case where a stereoscopic display in which a large number of pins each having a predetermined shape are arranged on the display surface is used as the display unit 121, the movement of the pins may be controlled to express the vibration.

The sound output unit 122 outputs a sound corresponding to the sound information data according to the control from the CPU 101. The sound output unit 122 is composed of a speaker, headphones connected to an output terminal, and the like.

The storage unit 108 stores various types of data and programs according to the control from the CPU 101. The CPU 101 reads various types of data from the storage unit 108 to process them, and executes a program.

The storage unit 108 is configured as an auxiliary storage device such as a semiconductor memory. The storage unit 108 may be configured as an internal storage or may be an external storage such as a memory card.

The communication unit 109 communicates with other devices via the network 50 according to the control from the CPU 101. The communication unit 109 is configured as a communication module that supports wireless communication such as wireless LAN or cellular type communication (for example, LTE-Advanced or 5G), or wired communication.

Note that the configuration of the information processing device 10 illustrated in FIG. 2 is an example, and may have, for example, an image processing circuit such as a GPU (Graphics Processing Unit), a short-range wireless communication circuit that performs wireless communication according to a short-range wireless communication standard such as Bluetooth (registered trademark) or NFC (Near Field Communication), a power supply circuit, and the like.

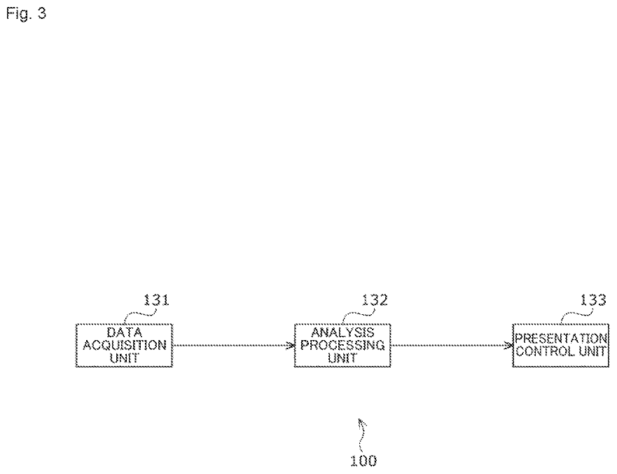

FIG. 3 illustrates a functional configuration example of a control unit 100 of the information processing device 10. The functions of the control unit 100 are implemented by the CPU 101 executing a predetermined program.

In FIG. 3, the control unit 100 includes a data acquisition unit 131, an analysis processing unit 132, and a presentation control unit 133.

The data acquisition unit 131 acquires data to be analyzed input therein and supplies the data to the analysis processing unit 132.

This data to be analyzed includes the captured image data captured by the camera unit 112 and the sensor data detected by the sensor unit 114. The data to be analyzed may be any data as long as it is used in the subsequent analysis processing, and the data to be analyzed may be, for example, the sound information data collected by the sound collection unit 113.

The analysis processing unit 132 performs analysis processing using the data to be analyzed supplied from the data acquisition unit 131, and supplies the result of analysis to the presentation control unit 133.

For example, the analysis processing unit 132 analyzes the state of the user by using the data to be analyzed such as the captured image data and the sensor data based on human visual characteristics. This state of the user includes a state such as the cognitive state and position of the user. The analysis processing unit 132 determines the shape of the effective region in the display region of the display unit 121 based on the result of analyzing the state of the user, and supplies that shape to the presentation control unit 133 as a result of analysis.

Also, for example, the analysis processing unit 132 analyzes the state of the space of the partner by using the captured image data, the sensor data, and the like. This state of the space of the partner includes the state of the partner user, the state of the environment of the space of the partner (weather, occurrence of an earthquake, and the like), the state of an object in the space of the partner (signs, sounds, and the like), and the like. The analysis processing unit 132 determines information on the presentation of the ineffective region in the display region of the display unit 121 based on the result of analyzing the state of the space of the partner, and supplies that information to the presentation control unit 133 as a result of analysis.

The presentation control unit 133 controls the display of the effective region or the ineffective region in the display region of the display unit 121 based on the result of analysis supplied from the analysis processing unit 132. The presentation control unit 133 also controls the output of sound by the sound output unit 122 and the vibration of (the surface corresponding to) the ineffective region in the display region of the display unit 121 by the vibration unit 123, based on the result of analysis supplied from the analysis processing unit 132.

As a result, the presentation control unit 133 controls the shape of the effective region in the display region of the display unit 121 so that the shape corresponds to the result of analyzing the state of the user. The presentation control unit 133 also controls the presentation of the ineffective region in the display region of the display unit 121 so that the presentation is made according to the result of analyzing the state of the space of the partner. At this time, the presentation control unit 133 performs a control for presenting the state of the space of the partner in all or part of the ineffective region corresponding to that state.

The information processing system 1 is configured as described above.

### Change in Shape of Display Region

In the information processing devices 10A and 10B connected via the network 50 in the information processing system 1, the shape of the effective region in the display region of the display unit 121 that displays the video of the space of the partner is variable such as changing from a rectangular shape to a circular shape, instead of being fixed to a rectangular shape having, for example, an aspect ratio of 4:3 or 16:9.

The information processing device 10 changes the shape of the effective region in the display region in order to cause the user to experience a changed spatial cognition and a changed cognitive sense of the sign of a person, thereby making it possible to make the user feel an appropriate change in the atmosphere of the space of the partner, which is the connection destination, and the sign the partner user, so that it is possible to provide a more appropriate connection between both spaces to make a natural communication between the users who are at remote locations.

More specifically, in the information processing device 10, the video displayed in the display region having a rectangular shape has an effect of making the user feel a clear sense of purpose and have an objective viewpoint, and is suitable for situations such as sharing video conferences and materials (particularly, materials mainly focusing on languages and symbols).

On the other hand, in situations where the users at remote regions wish to provide a natural sense of connection as if they are in the same space, or to make an accidental communication without a particular sense of purpose, the information processing device 10 can change the shape of the effective region in the display region to a circular shape.

In this way, the information processing device 10 displays a video including the partner user in the effective region having a circular shape, so that the users can make a more natural and comfortable remote communication by utilizing the effect of making it easier to capture information on the space of the partner user at the periphery of consciousness without paying attention to information in every detail.

Further, the shape of the effective region in the display region is not limited to a rectangle or a circle, and may be changed to another shape such as a vertically long ellipse or a semicircle.

More specifically, the information processing device 10 combines information such as the position of the user and the height and orientation of the viewpoint, and human visual characteristics (for example, visual field characteristics such as human visual field characteristic map information), so that it is possible to determine a suitable shape of the effective region according to any parameter for prioritizing visual information (for example, atmosphere, characters, signs, people, and the like) and control the shape of the effective region in the display region.

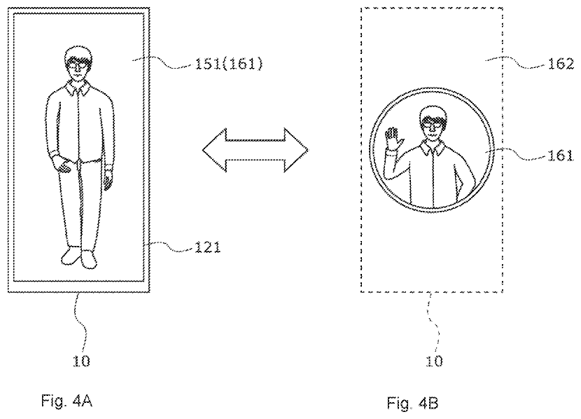

FIG. 4 illustrates an example of a change in the shape of an effective region 161 in a display region 151 of the display unit 121 of the information processing device 10.

The information processing device 10 having the rectangular-shaped display region 151 illustrated in A of FIG. 4 displays a video of the whole body of the partner user in the display region 151. Specifically, in A of FIG. 4, the display region 151 coincides with the effective region 161.

At this time, the information processing device 10 analyzes the state of the user by using the data to be analyzed such as the sensor data based on human visual characteristics. For example, the human visual characteristics include visual field characteristics such as a discrimination visual field, an effective visual field, a stable visual fixation field, an induced visual field, and an auxiliary visual field. The state of the user includes a state such as a user's cognitive state.

The information processing device 10 changes the shape of the effective region 161 in the display region 151 of the display unit 121 based on the result of analyzing the state of the user. In this example, the shape of the effective region 161 in the display region 151 is changed from the rectangular shape illustrated in A of FIG. 4 to the circular shape illustrated in B of FIG. 4.

The information processing device 10 illustrated in B of FIG. 4 displays a video of the upper body of the partner user in the effective region 161 having a circular shape. In the information processing device 10 illustrated in B of FIG. 4, the region excluding the effective region 161 in the display region 151 is the ineffective region 162.

In addition, the information processing device 10 can also change the shape of the effective region 161 in the display region 151 from the circular shape illustrated in B of FIG. 4 to the rectangular shape illustrated in A of FIG. 4 based on the result of analyzing the state of the user.

In this way, the information processing device 10 changes the shape of the effective region in the display region according to the state of the user, so that it is possible to give a natural and comfortable feeling of continuous connection. Although the details will be described later, in the analysis using the data to be analyzed, the context and the relative relationship with the partner user for example in addition to the state of the user may be analyzed, and the shape of the effective region in the display region may be controlled based on the result of analysis.

For example, by changing the shape of the effective region in the display region to a circle or ellipse, a telepresence system to improve the quality of relationships with remote locations can make the user feel the space and the partner user more naturally without the sense of invasion of privacy and excessive oriented purpose, and provide appropriate co-creation activities.

In addition, when the shape of the effective region in the display region is changed to a circle, an ellipse, or the like, the information processing device 10 can utilize the ineffective region as a mask region to present the state of the space of the partner. In this example, the state of the space of the partner is presented in the ineffective region 162 excluding the circular area of the effective region 161 in the rectangular display region 151 illustrated in B of FIG. 4.

This state of the space of the partner includes the state of the partner user, the state of the environment of the space of the partner (weather, occurrence of an earthquake, and the like), the state of an object in the space of the partner (signs, sounds, and the like), and the like, and the presentation of the ineffective region 162 in the display region 151 is controlled based on the result of analyzing the state of the space of the partner.

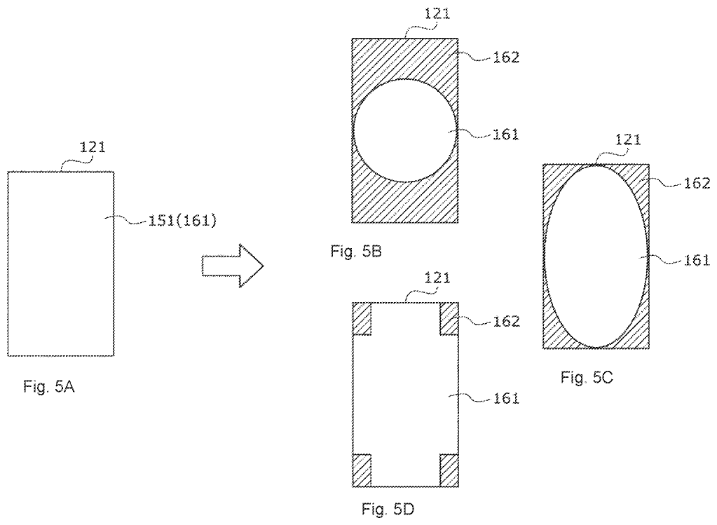

Note that although FIG. 4 illustrates a case where the shape of the effective region 161 in the display region 151 is changed between a rectangular shape and a circular shape, the shape of the effective region 161 may be one of various shapes that can be expressed by (the panel unit of) the display unit 121. FIGS. 5 to 7 illustrate examples of the shapes of the effective region 161 and the ineffective region 162 in the display region 151.

### First Example

FIG. 5 illustrates a first example of the shapes of the effective region 161 and the ineffective region 162 in the display region 151.

FIG. 5 illustrates a case where the shape of the effective region 161 in the display region 151 of the display unit 121 having the panel unit having a vertically long rectangular shape is changed to another shape.

As illustrated in A of FIG. 5, the original shape of the effective region 161 is a vertically long rectangular shape corresponding to the shape of the display region 151 of the panel unit of the display unit 121. That shape can be changed to a shape as illustrated in any of B to D of FIG. 5, for example.

In B of FIG. 5, the shape of the effective region 161 is changed from a vertically long rectangle to a circle. Further, in B of FIG. 5, the shape of the ineffective region 162 is composed of predetermined upper and lower regions excluding the circular area of the effective region 161 in the display region 151.

In C of FIG. 5, the shape of the effective region 161 is changed from a vertically long rectangle to a vertically long ellipse. Further, in C of FIG. 5, the shape of the ineffective region 162 is composed of predetermined four-corner regions excluding the elliptical area of the effective region 161 in the display region 151.

In D of FIG. 5, the shape of the effective region 161 is changed from a vertically long rectangle to a substantially cross shape excluding the four-corner rectangular regions. Further, in D of FIG. 5, the shape of the ineffective region 162 is composed of four-corner rectangular regions excluding the area of the effective region 161 in the display region 151.

### Second Example

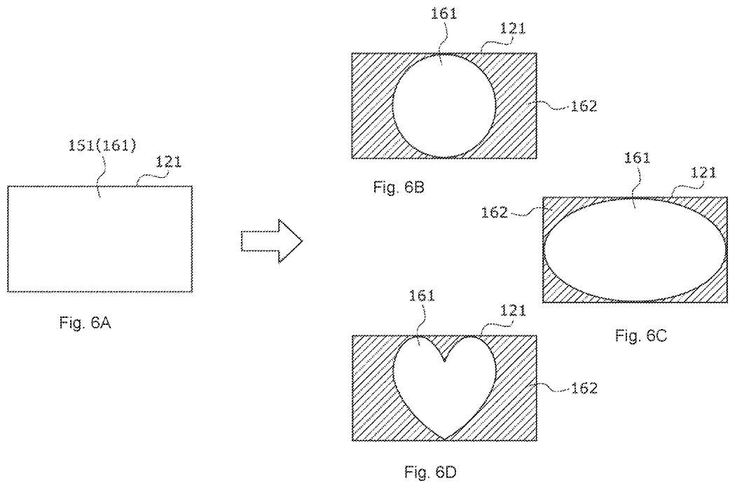

FIG. 6 illustrates a second example of the shapes of the effective region 161 and the ineffective region 162 in the display region 151.

FIG. 6 illustrates a case where the shape of the effective region 161 in the display region 151 of the display unit 121 having the panel unit having a horizontally long rectangular shape is changed to another shape.

As illustrated in A of FIG. 6, the original shape of the effective region 161 is a horizontally long rectangular shape corresponding to the shape of the display region 151 of the display unit 121. That shape can be changed to a shape as illustrated in any of B to D of FIG. 6, for example.

In B of FIG. 6, the shape of the effective region 161 is changed from a horizontally long rectangle to a circle. Further, in B of FIG. 6, the ineffective region 162 is composed of predetermined left and right regions excluding the circular area of the effective region 161 in the display region 151.

In C of FIG. 6, the shape of the effective region 161 is changed from a horizontally long rectangle to a horizontally long ellipse. Further, in C of FIG. 6, the ineffective region 162 is composed of predetermined four-corner regions excluding the elliptical area of the effective region 161 in the display region 151.

In D of FIG. 6, the shape of the effective region 161 is changed from a horizontally long rectangle to the shape of a predetermined symbol such as a heart shape. Further, in D of FIG. 6, the ineffective region 162 is composed of three regions excluding the symbol area of the effective region 161 in the display region 151.

### Third Example

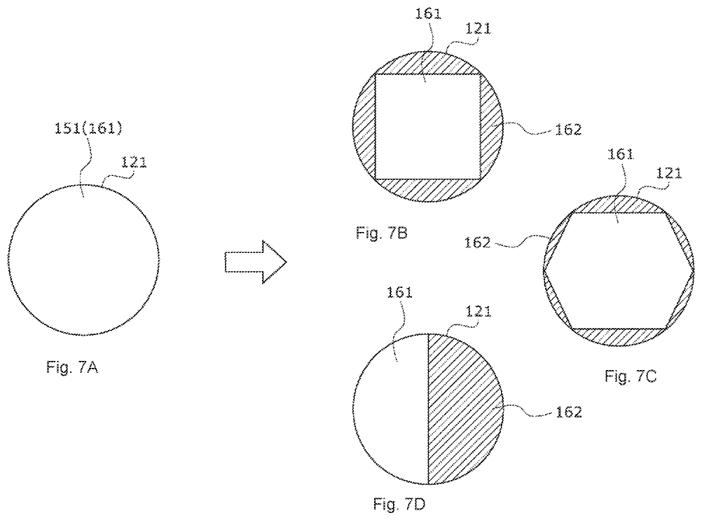

FIG. 7 illustrates a third example of the shapes of the effective region 161 and the ineffective region 162 in the display region 151.

FIG. 7 illustrates a case where the shape of the effective region 161 in the display region 151 of the display unit 121 having the panel unit having a circular shape is changed to another shape.

As illustrated in A of FIG. 7, the original shape of the effective region 161 is a circular shape corresponding to the shape of the display region 151 of the display unit 121. That shape can be changed to a shape as illustrated in any of B to D of FIG. 7, for example.

In B of FIG. 7, the shape of the effective region 161 is changed from a circle to a rectangle (square). Further, in B of FIG. 7, the ineffective region 162 is composed of four bow-shaped regions excluding the rectangular (square) area of the effective region 161 in the display region 151.

In C of FIG. 7, the shape of the effective region 161 is changed from a circle to a polygon (hexagon). Further, in C of FIG. 7, the ineffective region 162 is composed of six bow-shaped regions excluding the rectangular (hexagonal) area of the effective region 161 in the display region 151.

In D of FIG. 7, the shape of the effective region 161 is changed from a circle to a semicircle. In D of FIG. 7, the ineffective region 162 is composed of a semicircular region on the opposite side excluding the semicircular area of the effective region 161 in the display region 151.

As described above, in the information processing device 10, the shapes of the effective region 161 and the ineffective region 162 in the display region 151 of the display unit 121 can be changed to various shapes by controlling the graphical display or the like. Note that the shapes of the effective region 161 and the ineffective region 162 in the display region 151 described above are examples, and may be changed to other shapes.

### User Visual Characteristics

For the human visual characteristics used when analyzing a state of the user, for example, human visual field characteristics can be used.

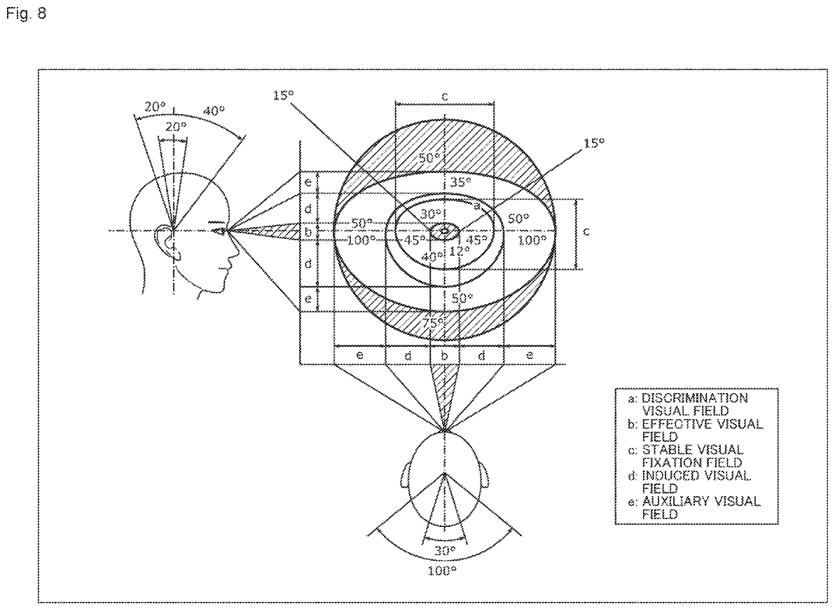

FIG. 8 illustrates an example of human visual field characteristics.

In FIG. 8, for the human eye being schematically represented, the information receiving characteristics in human visual fields are represented by five characteristics: a discrimination visual field, an effective visual field, a stable visual fixation field, an induced visual field, and an auxiliary visual field.

The discrimination visual field is indicated by “a” in FIG. 8, and is in a range in which visual functions such as visual acuity and color discrimination are excellent, and highly accurate information can be received. For example, the discrimination visual field is within a range of a few degrees.

The effective visual field is indicated by “b” in FIG. 8, and is in a range in which information is gazed only by the eye movement, and specific information can be instantly received even from noise. For example, the effective visual field is within a range of about 15 degrees to the left and right, about 8 degrees above, and about 12 degrees below.

The stable visual fixation field is indicated by “c” in FIG. 8, and is generated in a state where the head movement assists the eye movement, and is in a range in which gaze can be performed reasonably. For example, the stable visual fixation field is within a range of 30 to 45 degrees to the left and right, 20 to 30 degrees above, and 25 to 40 degrees below.

The induced visual field is indicated by “d” in FIG. 8, and a range in which a sense of discernment to the extent that only the existence of the presented information can be discriminated is exercised, but it affects the human sense of spatial coordinates. For example, the induced visual field is in a range of 30 to 100 degrees horizontally and 20 to 85 degrees vertically.

The auxiliary visual field is indicated by “e” in FIG. 8, and is in a range in which the reception of information is extremely reduced, and it has an auxiliary function to the extent that a gaze motion is induced by a strong stimulus or the like. For example, the auxiliary visual field is in a range of 100 to 200 degrees horizontally and 85 to 135 degrees vertically.

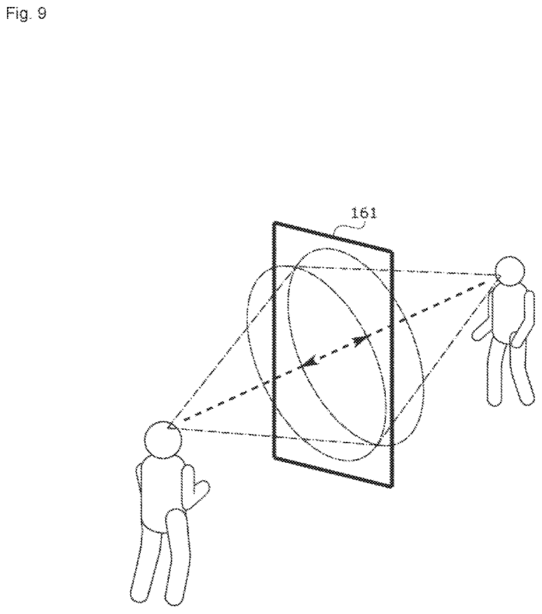

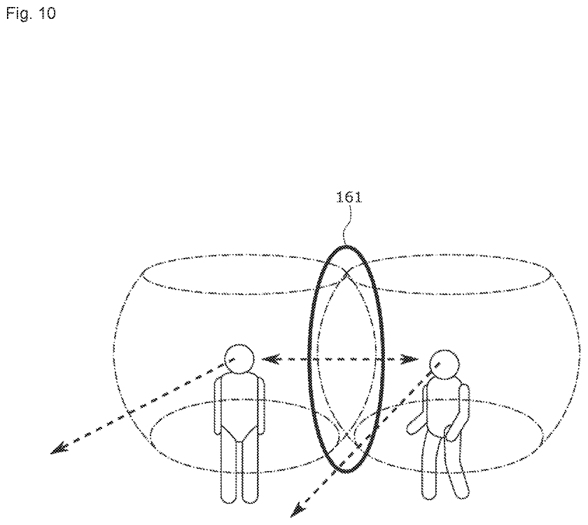

Further, when users at remote locations communicate with each other by the information processing devices 10A and 10B connected via the network 50 in the information processing system 1, it is expected that the positional relationships between the users are as illustrated in FIGS. 9 and 10, for example.

As illustrated in FIG. 9, in the situation where one user faces the other user through the effective region 161 in the display region 151 of the information processing device 10 installed in each remote space, it is possible to provide a deep conversation through their visual, auditory, and interpersonal senses.

On the other hand, as illustrated in FIG. 10, in the situation where users are side by side through the effective region 161 in the display region 151 of the information processing device 10 installed in each remote space, deliberately shifting the directions of their senses, mainly the visual sense, makes it possible to aim for a gentle, creative place that does not force conversation.

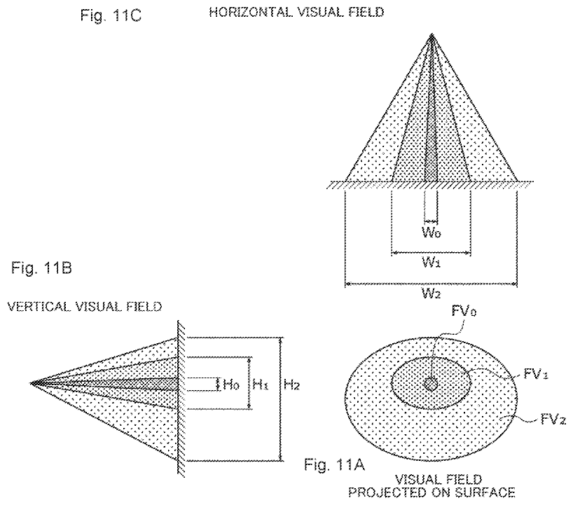

FIG. 11 illustrates the relationship between the discrimination visual field, the effective visual field, and the stable visual fixation field.

In FIG. 11, the relationship between the discrimination visual field, the effective visual field, and the stable visual fixation field is represented by the relationship between a visual field projected on a certain surface and vertical and horizontal visual fields with respect to the surface.

The discrimination visual field is represented by a visual field FV₀ which is the region of the innermost ellipse of the horizontally long ellipses illustrated in A of FIG. 11 and has a high-density dot pattern, and is also represented by the following Equation (1) with the relationship between a height H₀ of the vertical visual field and a width W₀ of the horizontal visual field.

Discrimination visual field FV₀: W₀×H₀ (1)

The effective visual field is represented by a visual field FV₁ which is the region of the ellipse between the regions of the innermost ellipse and the outermost ellipse of the horizontally long ellipses illustrated in A of FIG. 11 and has a medium-density dot pattern, and is also represented by the following Equation (2) with the relationship between a height H₁ of the vertical visual field and a width W₁ of the horizontal visual field.

Effective visual field FV₁: W₁×H₁ (2)

The stable visual fixation field is represented by a visual field FV₂ which is the region of the outermost ellipse of the horizontally long ellipses illustrated in A of FIG. 11 and has a low-density dot pattern, and is also represented by the following Equation (3) with the relationship between a height H₂ of the vertical visual field and a width W₂ of the horizontal visual field.

Stable visual fixation field FV₂: W₂×H₂ (3)

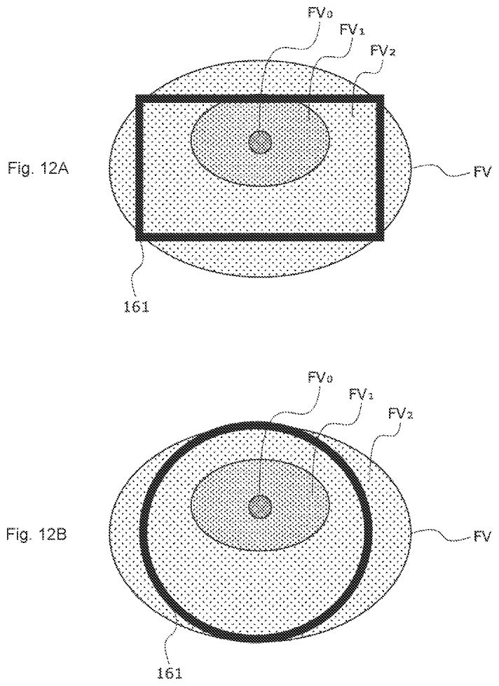

In the case where the human visual field characteristics are used as the human visual characteristics, for the visual fields FV including the discrimination visual field FV₀, the effective visual field FV₁, and the stable visual fixation field FV₂, the relationship with the effective region 161 having a rectangular shape is illustrated in A of FIG. 12, and the relationship with the effective region 161 having a circular shape is illustrated in B of FIG. 12.

As illustrated in A of FIG. 12 and B of FIG. 12, for the different shapes of the effective regions 161 in the display region 151, that is, the rectangular shape and the circular shape, the relationship between the discrimination visual field FV₀, the effective visual field FV₁, and the stable visual fixation field FV₂ in the effective region 161, that is, the human visual field characteristics, are different accordingly.

Further, the ineffective region 162 in the display region 151 is a region corresponding to the stable visual fixation field FV₂. Therefore, the state of the space of the partner presented in the ineffective region 162 is presented in a range where the user can comfortably gaze, so that the user can visually recognize the state of the space of the partner while continuing to look at the effective region 161 without deviating the line of sight.

In other words, in the information processing device 10, since the state of the space of the partner is presented in the ineffective region 162, information can be presented such as complementary information of a video displayed in the effective region 161 and information having no direct relation with a video displayed in the effective region 161.

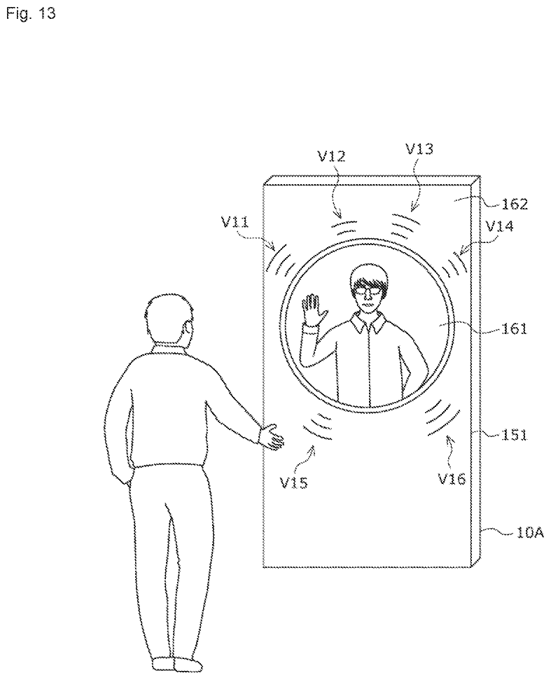

Hereinafter, FIGS. 13 to 20 illustrate examples in which the information processing device 10A utilizes the ineffective region 162 in the display region 151 of the display unit 121 to present the state of the space where the information processing device 10B is installed (the space of the partner, which is the connection destination).

### First Example

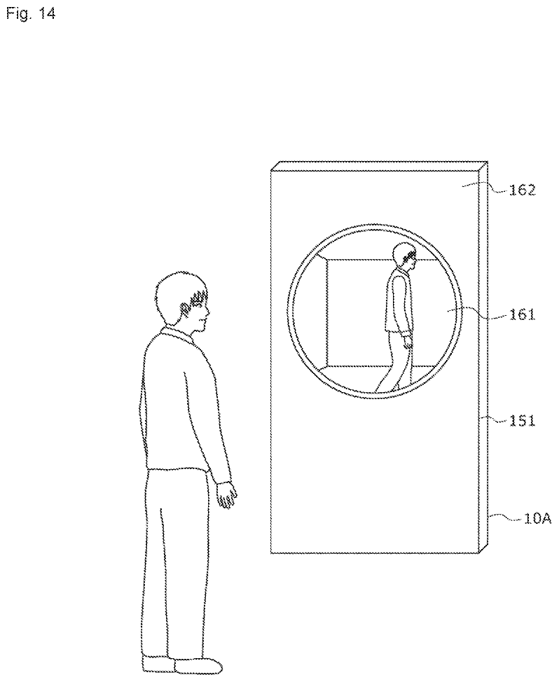

FIGS. 13 and 14 illustrate first examples of presenting a state of the partner space by using the ineffective region 162.

In FIG. 13, the information processing device 10A installed in the space at point A displays an aspect in the space at point B where the information processing device 10B is installed, in the effective region 161 having a circular shape in the display region 151 of the display unit 121. In the information processing device 10A, an aspect of the partner user near the information processing device 10B appears in the effective region 161, and the user in the space at point A communicates with the partner user in the space at point B.

Meanwhile, when the information processing device 10A recognizes the state of communication between the user and the partner user and detects that the communication is active, the ineffective region 162 is vibrated according to the level of excitement of the communication. In the example of FIG. 13, as represented by vibrations V11 to V16, a region of the ineffective region 162 around the effective region 161 is slightly vibrated according to the excitement of conversation or the like. Note that it can be said that the level of excitement is the degree of activity.

On the other hand, in FIG. 14, in the information processing device 10A, an aspect of the partner user moving in the space at point B appears in the effective region 161, and the user is not communicating with the partner user. Meanwhile, the information processing device 10A does not detect any communication between the users, so that the ineffective region 162 is not vibrated.

In this way, when the communication between the users is active, the ineffective region 162 around the effective region 161 in which the partner user appears is vibrated (slightly vibrated), so that the user can experience through the vibration according to the level of the excitement the excitement of conversation and the like in the space of the partner, which is the connection destination.

Here, how to obtain the level of excitement includes, for example, determining whether both users have a well-balanced speech sequence (for example, not a one-sided conversation) or whether both users communicate with feelings as if they are in the same space, based on information obtained from the sound input to the sound collection unit 113 and the sound output from the sound output unit 122 in both the information processing devices 10A and 10B, and obtaining the level of excitement according to the result of determination.

Note that although the information processing device 10A installed in the space at point A has been described in this example, the information processing device 10B installed in the space at point B can also vibrate the ineffective region 162 according to the level of excitement of communication between the users in the same manner as the information processing device 10A.

### Second Example

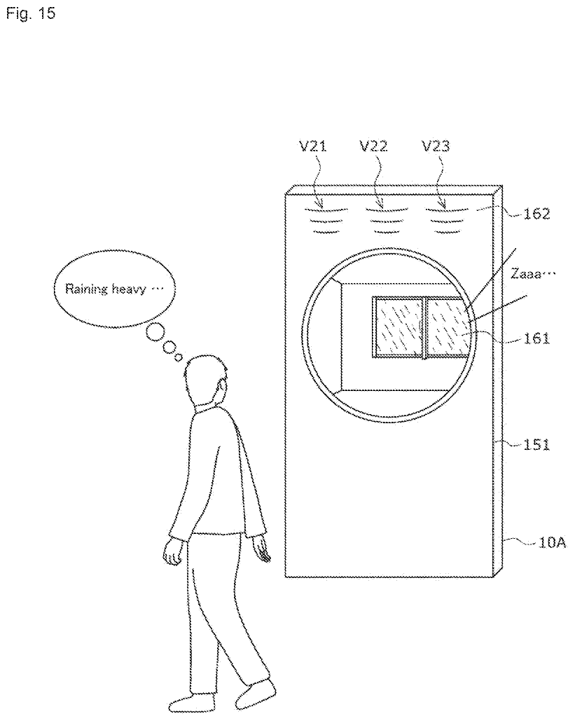

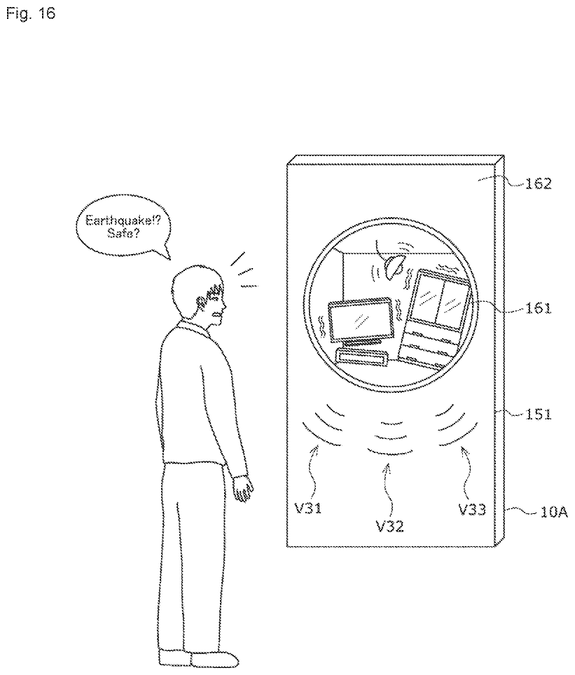

FIGS. 15 and 16 illustrate second examples of presenting a state of the partner space by using the ineffective region 162.

In FIG. 15, the information processing device 10A installed in the space at point A displays an aspect in the space at point B where the information processing device 10B is installed, in the effective region 161 having a circular shape in the display region 151 of the display unit 121. In the information processing device 10A, an aspect of a room in which the information processing device 10B is installed appears in the effective region 161, and rain hits the window.

Meanwhile, the information processing device 10A acquires the environmental information of the space at point B, which is the connection destination, and when the information processing device 10A detects that it is raining such as heavy rain or a typhoon, the ineffective region 162 is vibrated according to the rain condition. In the example of FIG. 15, as represented by vibrations V21 to V23, a region of the ineffective region 162 above the effective region 161 (close to the ceiling) is slightly vibrated in synchronization with the sound of rain or the like. Note that, in a situation where the sound of a typhoon or wind is strong, the entire region of the ineffective region 162 may be shaken according to that condition.

Further, in FIG. 16, in the information processing device 10A, an aspect of a room in which the information processing device 10B is installed appears in the effective region 161 having a circular shape, and home appliances and furniture are shaking due to the impact of an earthquake occurring in the locality of the space at point B, which is a remote locality.

Meanwhile, the information processing device 10A acquires the environmental information of the space at point B, which is the connection destination, and when the information processing device 10A detects shaking due to the earthquake, the ineffective region 162 is vibrated according to the earthquake condition (seismic intensity, shaking, and the like). In the example of FIG. 16, as represented by vibrations V31 to V33, a region of the ineffective region 162 below the effective region 161 (close to the floor) is slightly vibrated in synchronization with the shaking of the earthquake or the like. Note that, in a situation where the shaking of the earthquake is large, the entire region of the ineffective region 162 may be shaken according to that condition.

In this way, when the space of the partner, which is the connection destination, is in an unsteady state (heavy rain, typhoon, earthquake, and the like), a predetermined region in the ineffective region 162, for example, above or below the effective region 161 in which the space of the partner is displayed is vibrated (slightly vibrated). Therefore, the user can experience that heavy rain or an earthquake is occurring in the space of the partner by vibration according to the unsteady state.

Note that although heavy rains, typhoons, and earthquakes are taken as examples in the above description, the environmental information may include information on meteorological phenomena such as weather, weather conditions, sunshine, atmospheric pressure, temperature, humidity, precipitation, snowfall, wind speed, and wind direction, as well as information on various environments such as information on other natural disasters, and based on such environmental information, the information processing device 10 vibrates a predetermined region of the ineffective region 162.

### Third Example

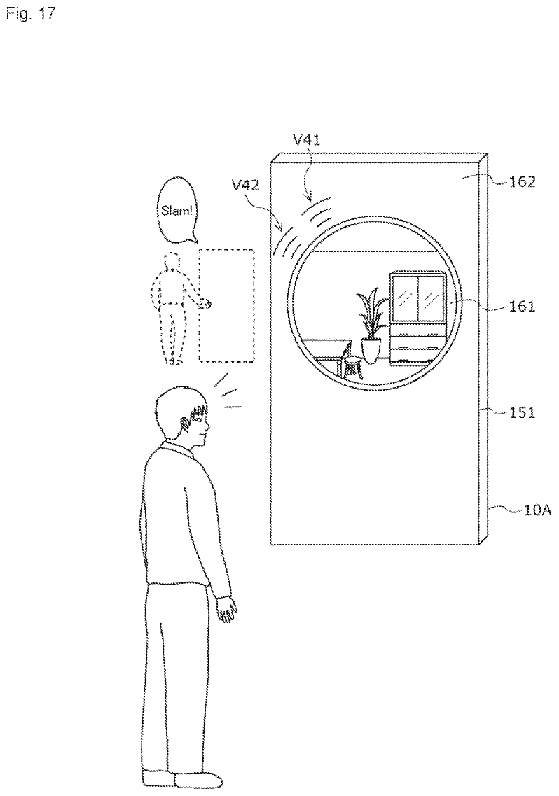

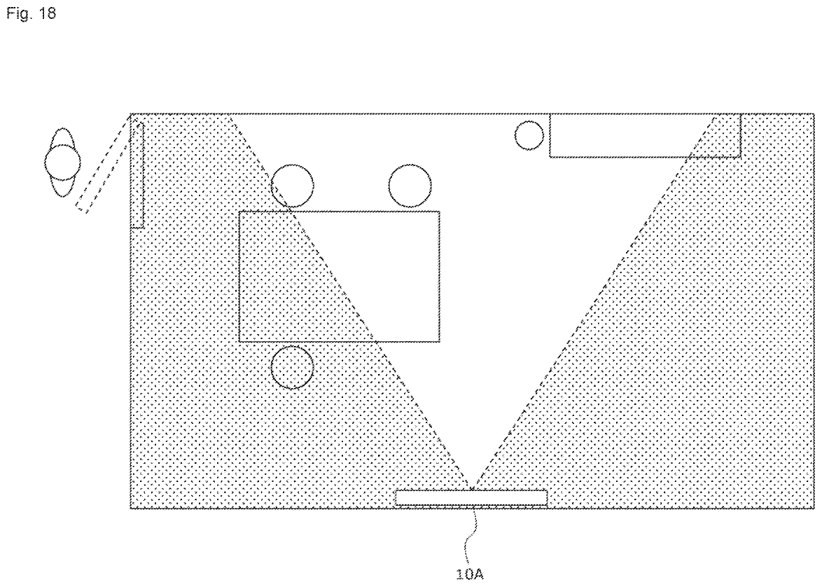

FIGS. 17 and 18 illustrate third examples of presenting a state of the partner space by using the ineffective region 162.

In FIG. 17, the information processing device 10A installed in the space at point A displays an aspect in the space at point B where the information processing device 10B is installed, in the effective region 161 having a circular shape in the display region 151 of the display unit 121. In the information processing device 10A, an aspect of a room in which the information processing device 10B is installed appears in the effective region 161, and there is no particular change, that is, it is in a steady state.

In this state, it is assumed that a door of the room is opened and the partner user enters the space at point B. FIG. 18 is a plan view of the room in the space at point B, and the position of the door of the room is not included in the angle of view of the camera unit 112 provided in the information processing device 10B. Accordingly, the door of the room is outside the angle of view of the camera unit 112, so that the aspect of the partner user when the door is opened cannot be displayed in the effective region 161 in the display region 151 of the information processing device 10A.

The information processing device 10A acquires sign and sound information of the space at point B, which is the connection destination, as out-of-angle information, and when information processing device 10A detects a sign or a movement sound of an object from a certain direction, the ineffective region 162 is vibrated according to the direction of arrival of such as the sign or sound. In the example of FIG. 17, as represented by vibrations V41 and V42, a region of the ineffective region 162 on the left side (door side) of the effective region 161 is slightly vibrated in synchronization with the door opened by the partner user.

In this way, when a sign or a movement sound, but not displayed in the effective region 161, is generated from an object such as the partner user or a thing in the space of the partner, which is the connection destination, a predetermined region of the ineffective region 162 corresponding to the direction of arrival of the sign or movement sound is vibrated (slightly vibrated), so that the user can intuitively grasp the position of the object such as the partner user even in a place not visible in the effective region 161.

### Fourth Example

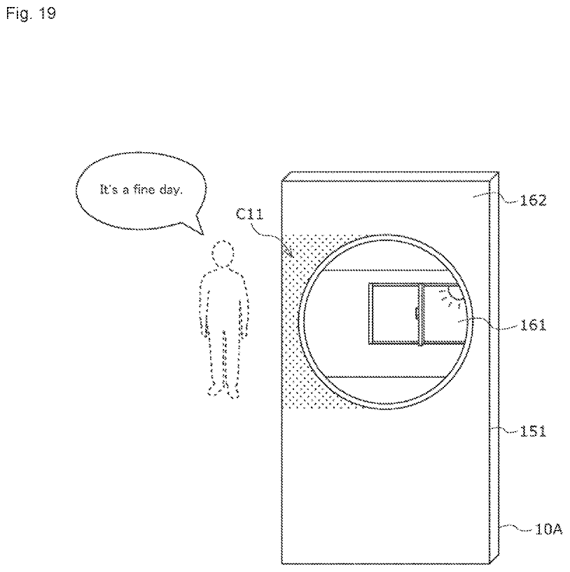

FIG. 19 illustrates a fourth example of presenting a state of a partner space by using the ineffective region 162.

In FIG. 19, the information processing device 10A installed in the space at point A displays an aspect in a room where the information processing device 10B is installed, in the effective region 161 having a circular shape in the display region 151 of the display unit 121, and there is no particular change, that is, it is in a steady state.

In this state, it is assumed that the partner user outside the angle of view of the camera unit 112 provided in the information processing device 10B speaks in the space at point B. The information processing device 10A acquires sign and sound information of the space at point B, which is the connection destination, and when the information processing device 10A detects speech of the partner user, the ineffective region 162 is visually changed according to the position and direction of the sound source.

In the example of FIG. 19, as represented by a visual change C11, a region of the ineffective region 162 on the left side (partner user side) of the effective region 161 is visually changed in synchronization with the partner user's speech. A method of realizing this visual change can include, for example, changing (varying) the texture, color, brightness, and the like in a predetermined region of the ineffective region 162.

In this way, not only by vibrating the ineffective region 162 but also by visually changing the ineffective region 162, the user can feel the sign and the direction of arrival of speech of the partner user in the space of the partner, which is the connection destination.

### Fifth Example

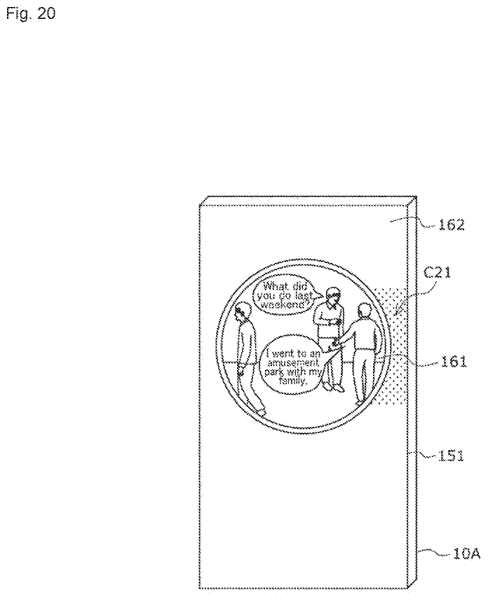

FIG. 20 illustrates a fifth example of presenting a state of a partner space by using the ineffective region 162.

In FIG. 20, the information processing device 10A installed in the space at point A displays an aspect in a room where the information processing device 10B is installed, in the effective region 161 having a circular shape in the display region 151 of the display unit 121, and there are a plurality of partner users, and specific partner users are talking. In the example of FIG. 20, among the partner users appearing in the video displayed in the effective region 161, two partner users in the right area are actively talking.

Meanwhile, the information processing device 10A acquires sign and sound information of the space at point B, which is the connection destination, and the corresponding area of the ineffective region 162 is visually changed according to the conversation and noise of the two partner users talking.

In the example of FIG. 20, as represented by a visual change C21, a region of the ineffective region 162 on the right side (side of the talking partner users) of the effective region 161 is visually changed by changing the texture, color, brightness, and the like in synchronization with the conversation of the two partner users.

Such a visual change of the ineffective region 162 according to the conversation and noise of the partner users makes it possible to make the user feel who is talking in the space at point B, which is the connection destination, and what generates the sound. Further, even when the noise level on the space side at point A is high or the volume of the information processing device 10A is turned down, the user can intuitively grasp the acoustic condition of the space at point B, which is the connection destination.

Note that although the example described with reference to FIGS. 13 to 20 is a case where vibration or a visual change is used to present the state of the space of the partner, any presentation method may be used as long as it can present the state of the space of the partner. For example, as a presentation method, it is possible to use a method of presenting a state of the space at point B so as to make the user in the space at point A feel that state by at least one of sensory functions of visual, auditory, and haptic senses.

### Flow of Processing of Each Device

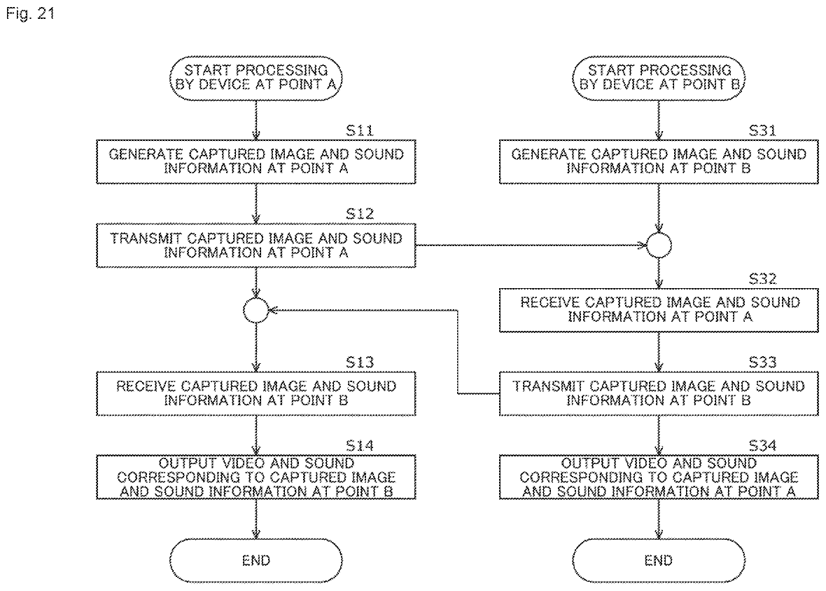

Next, with reference to a flowchart of FIG. 21, the flow of processing performed between the information processing device 10A installed in the space at point A and the information processing device 10B installed in the space at point B will be described.

In FIG. 21, the processing of steps S11 to S14 is executed by the information processing device 10A installed in the space at point A.

In the information processing device 10A, the camera unit 112 generates captured image data, the sound collection unit 113 generates sound information data (S11), and the generated captured image and sound information data are transmitted to the information processing device 10B via the network 50 (S12).

Further, the information processing device 10A receives captured image and sound information data transmitted from the information processing device 10B via the network 50 (S13), and outputs video and sound in the space at point B based on the received captured image and sound information data (S14).

On the other hand, the processing of steps S31 to S34 is executed by the information processing device 10B installed in the space at point B.

In the information processing device 10B, the camera unit 112 generates the captured image data, the sound collection unit 113 generates the sound information data (S31), and the generated captured image and sound information data are transmitted to the information processing device 10A via the network 50 (S33).

Further, the information processing device 10B receives the captured image and the sound information data transmitted from the information processing device 10A via the network 50 (S32), and outputs video and sound in the space at point A based on the received captured image and sound information data (S34).

As described above, between the information processing devices 10A and 10B, data, such as captured images captured by their camera units 112, and sounds collected by their sound collection units 113, is transmitted and received, for example, regularly in real time while connection of both sides is established. Note that various types of data such as sensor data as well as captured images and sound data are transmitted and received between the information processing device 10A and the information processing device 10B, but the description thereof is omitted in detail herein.

The information processing device 10A displays the video captured by the information processing device 10B and outputs the collected sound, while the information processing device 10B displays the video captured by the information processing device 10A and outputs the collected sound. Thus, the user of each of the information processing devices 10A and 10B can feel as if the partner user of each of the information processing devices 10B and 10A is present in opposite to, that is, on the opposite side of, each of the information processing devices 10A and 10B located nearby.

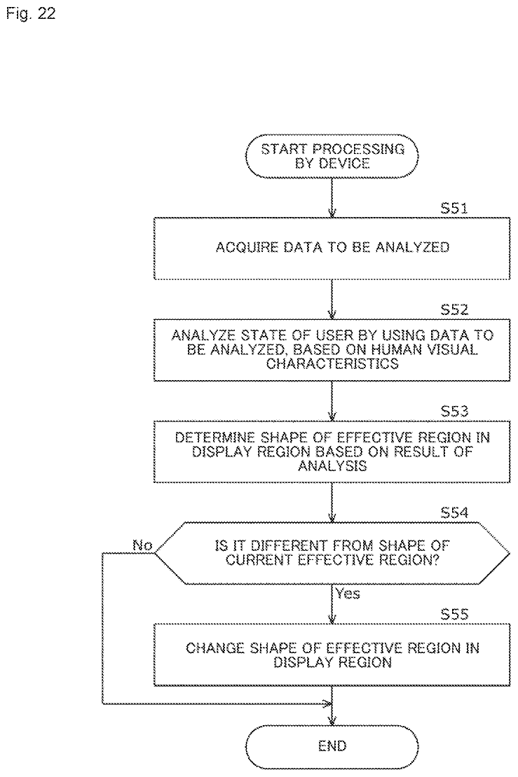

Next, with reference to the flowchart of FIG. 22, display region shape control processing executed by each of the information processing device 10A at point A and the information processing device 10B at point B will be described.

In step S51, the data acquisition unit 131 acquires captured image data captured by the camera unit 112, sensor data detected by the sensor unit 114, and the like as data to be analyzed.

The data to be analyzed is not limited to the data acquired by the information processing device 10 (10A or 10B) installed in its own space (at point A or point B), and also includes data transmitted from the information processing device 10 (10B or 10A) installed in the space of the partner (at point B or point A).

In step S52, the analysis processing unit 132 performs processing of analyzing the state of the user by using the acquired data to be analyzed based on human visual characteristics.

As the human visual characteristics, the human visual field characteristics described with reference to FIGS. 8 to 12 can be used, for example. Further, the state of the user includes a user's cognitive state and the like, for example. Specifically, in the processing of analyzing the state of the user, the visual field characteristics including the discrimination visual field, the effective visual field, the stable visual fixation field, and the like are defined as a standard visual ability, and so-called visual cognitive characteristic information is used involving individual characteristics of and conditions for each user in that standard visual ability.

In step S53, the analysis processing unit 132 determines the shape of the effective region 161 in the display region 151 of the display unit 121 based on the result of analyzing the state of the user.

In step S54, the analysis processing unit 132 determines whether or not the determined shape of the effective region 161 is different from the shape of the current effective region 161.

If it is determined in the determination processing of step S54 that the determined shape of the effective region 161 is different from the shape of the current effective region 161, the processing proceeds to step S55.

In step S55, the presentation control unit 133 controls the display of (the panel unit of) the display unit 121 to change the shape of the current effective region 161 in the display region 151 to the determined shape of the effective region 161.

More specifically, in the information processing device 10, when the shape of the current effective region 161 in the display region 151 is a rectangle, and the determined shape of the effective region 161 is a circle, that is, when their shapes are different, the shape of the effective region 161 is changed from the rectangle to the circle (examples in A and B of FIG. 4).

At this time, for example, the presentation control unit 133 can set an area corresponding to the circular shape on the panel unit of the display unit 121 as the effective region 161 and set an area excluding the area corresponding to the circular shape as the ineffective region 162 (for example, a black region or the like), so that the shape of the effective region 161 in the display region 151 can be changed to a circle. Further, when the shape of the effective region 161 is changed, that shape may be continuously changed from the rectangle to the circle, or that shape may be changed discontinuously (may be instantaneously switched from the rectangle to the circle).

In a case where a projector is used as the display unit 121, the shape of the projection surface of a video projected by the projector may be changed from the rectangle to the circle.

On the other hand, if it is determined in the determination processing of step S54 that the determined shape of the effective region 161 is the same as the shape of the current effective region 161, the processing of step S55 is skipped and then the current processing ends.

The flow of the display region shape control processing has been described above. In this display region shape control processing, each of the information processing devices 10A and 10B does not fix the shape of the effective region 161 in the display region 151 of the display unit 121 that displays a video of the partner user at a remote location to a shape such as a rectangle, but changes the shape of the display region 151 from a rectangle to a circle or the like according to the result of analyzing the state of the user. Therefore, it is possible to suitably change the user's feeling of the atmosphere of the space of the partner, which is the connection destination, the way of making the user feel the sign of the partner user, and the like. Therefore, users at remote locations can communicate with each other more naturally.

Note that the above-described analysis processing is for analyzing the state of the user by way of example, but it is not limited to the state of the user, and for example, the context and the relative relationship with the partner user may be analyzed and involved in the result of analysis.

Specifically, the analysis processing unit 132 analyzes the context based on the data to be analyzed such as sensor data, and the presentation control unit 133 controls the shape of the effective region 161 in the display region 151 based on the result of analyzing at least one of the state of the user and the context.

In addition, when analyzing the context based on the data to be analyzed such as the sensor data, the analysis processing unit 132 may analyze the influence on the user due to the context, and analyze the cognitive state of the user based on the result of analyzing the influence on the user. Such an analysis on the cognitive state of the user using the context makes it possible to reduce the cost as compared with the case of analyzing the cognitive state by sensing brain waves, living body, behavior and the like.

Examples of the context can include information on the situation where the information processing device 10 is used, such as information on the space where the information processing device 10 is installed, information on the weather around the space, and information on the building providing the space or the equipment of the building.

Further, the analysis processing unit 132 analyzes the relative relationship with the partner user based on the data to be analyzed such as sensor data, and the presentation control unit 133 controls the shape of the effective region 161 in the display region 151 based on the result of analyzing at least one of the state of the user and the relative relationship.

For example, by analyzing the relative relationship with the partner user, the shape of the effective region 161 in the display region 151 can be changed to a shape with a high degree of openness or a shape with a high privacy protection according to the intimacy and reliability of the users in the respective spaces where the information processing devices 10A and 10B are installed. Further, for example, the shape of the effective region 161 in the display region 151 may be changed to be a suitable shape depending on the conditions such as the case where the main user is present in either of the spaces or the case where there is almost no person.

In addition, when changing the shape of the effective region 161 in the display region 151, the information processing device 10 may change that shape to a shape estimated from the data to be analyzed such as sensor data, by using a determination model trained by machine learning using learning data regarding the shape of the display region. As such a machine learning method, for example, a neural network or deep learning can be used. Further, the information processing device 10 may set the initial shape of the effective region 161 in the display region 151 to a shape corresponding to the position of the user (an expected position of the user) with respect to the information processing device 10.

Further, the information processing device 10 may sense the movement of the user's gaze point (line of sight) (for example, including detection of brain waves and biological information, as well as speech analysis and behavior analysis) to estimate the user's cognition and intracerebral mode, and bring the shape of the effective region 161 in the display region 151 closer to a shape suitable for that state. On the contrary, the shape of the effective region 161 in the display region 151 may be changed in the direction of change to a cognitive mode to be induced. In addition, such processing may be executed so as to optimize the cognitive ability (visual acuity, knowledge, experience, preference, and the like) of each user.

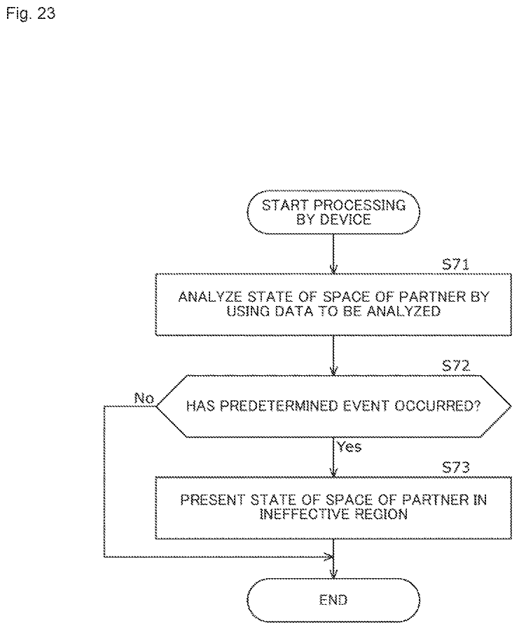

Next, with reference to the flowchart of FIG. 23, partner space state presentation control processing executed by each of the information processing device 10A at point A and the information processing device 10B at point B will be described.

Note that this partner space state presentation control processing is processing to be executed after the shape of the effective region 161 in the display region 151 is changed from a rectangle to another shape such as a circle by the above-described display region shape control processing, and as a result, the ineffective region 162 is present.

In step S71, the analysis processing unit 132 performs processing of analyzing the state of the space of the partner by using the acquired data to be analyzed.

In step S72, the analysis processing unit 132 determines whether or not a predetermined event has occurred in the space of the partner based on the result of analyzing the state of the space of the partner.

If it is determined in the determination processing of step S72 that a predetermined event has occurred, the processing proceeds to step S73.

In step S73, the presentation control unit 133 controls the output unit 107 to present the state of the space of the partner in the ineffective region 162 in the display region 151.

For example, as described with reference to FIGS. 13 to 20, as the state of the space of the partner, the degree of activity of communication between the users may be presented, the degree of weather or earthquake in the space of the partner may be presented, or signs and sounds outside the angle of view may be presented. Further, the state of the space of the partner is presented so as to make the user feel that state by at least one of sensory functions of visual, auditory, and haptic senses.

On the other hand, if it is determined in the determination processing of step S72 that a predetermined event has not occurred, the processing of step S73 is skipped and then the current processing ends.

The flow of the partner space state presentation control processing has been described above. In this partner space state presentation control processing, when the shape of the effective region 161 in the display region 151 is changed to form the ineffective region 162 by the above-described display region shape control processing, this ineffective region 162 is utilized to present the state of the space of the partner to the user. Therefore, the user can recognize not only the video displayed in the effective region 161 but also the state of the space of the partner presented in the ineffective region 162, so that the user can grasp the situation of the space of the partner at a remote location more deeply.

### 2. MODIFICATION EXAMPLES

### Other System Configurations

In the description with reference to FIGS. 2 and 3, the control unit 100 is provided in the information processing device 10. However, all or part of the control unit 100 may be implemented by a server connected to the network 50.

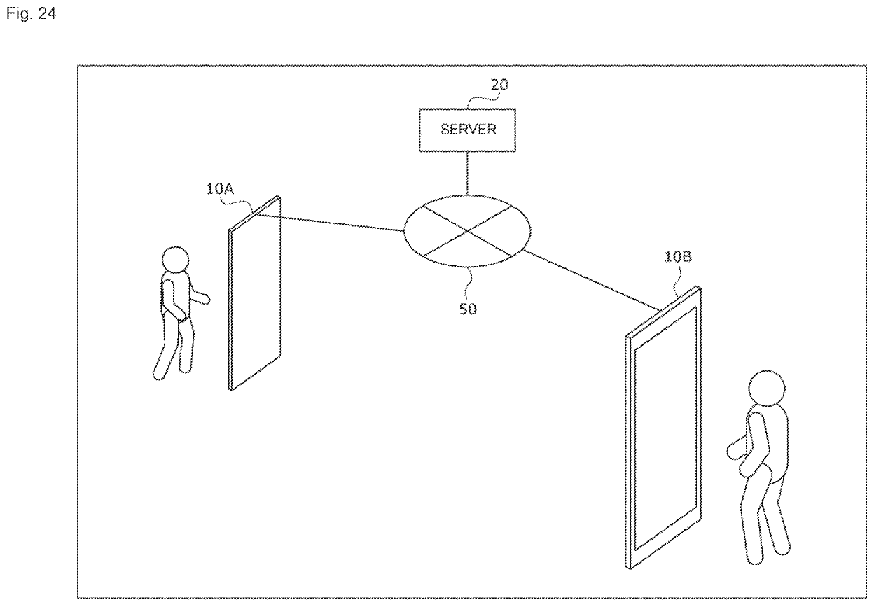

FIG. 24 is a diagram illustrating another configuration example of an embodiment of an information processing system to which the present technology is applied.

The information processing system illustrated in FIG. 24 is configured of the information processing device 10A, the information processing device 10B, and a server 20, which are connected to each other via the network 50 such as the Internet. The server 20 has the configuration of all or part of the control unit 100 described with reference to FIG. 3.

In this way, the control unit 100 may be provided external to the information processing device 10.

For example, various types of data such as captured images, sound information, and environmental information are transmitted from the information processing device 10 to the server 20. Also, for example, various types of data such as captured images, sound information, and environmental information of the connection destination are transmitted from the information processing device 10 to the server 20.

A home server for controlling the information processing device 10 may be provided for the information processing device 10.

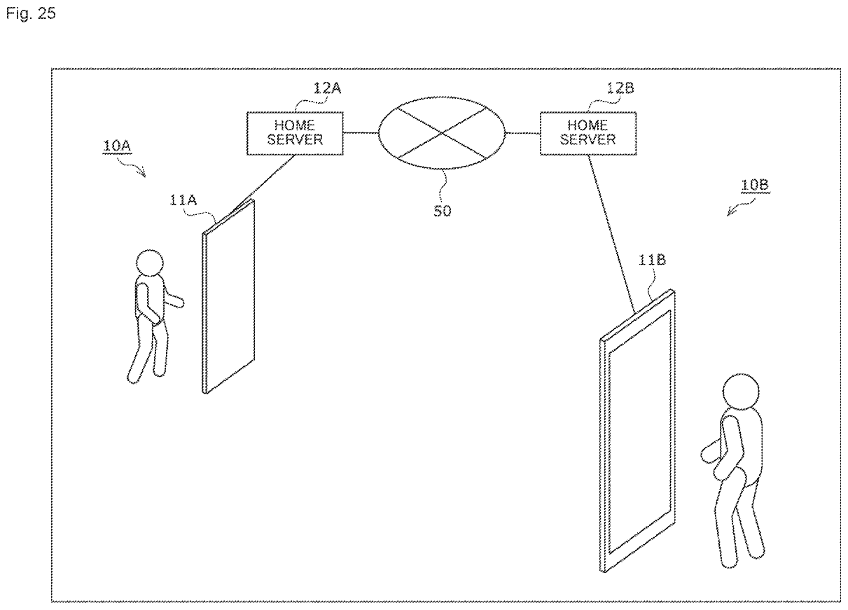

FIG. 25 is a diagram illustrating still another configuration example of an embodiment of an information processing system to which the present technology is applied.

The information processing system illustrated in FIG. 25 is configured of the information processing device 10A and the information processing device 10B, which are connected to each other via the network 50.

The information processing device 10A includes an input/output unit 11A and a home server 12A. The input/output unit 11A has at least the configurations of the input unit 106 (FIG. 2) and the output unit 107 (FIG. 2). The home server 12A has at least the configurations of the control unit 100 (FIG. 3) and the communication unit 109 (FIG. 2). The home server 12A is connected to the home server 12B of the information processing device 10B via the network 50.

Similarly, the information processing device 10B includes an input/output unit 11B and a home server 12B. The input/output unit 11B has at least the configurations of the input unit 106 (FIG. 2) and the output unit 107 (FIG. 2). The home server 12B has at least the configurations of the control unit 100 (FIG. 3) and the communication unit 109 (FIG. 2). The home server 12B is connected to the home server 12A of the information processing device 10A via the network 50.

In this way, the configuration of the control unit 100 or the like may be provided external to the input/output unit 11 including the display unit 121 or the like.

Note that a partial configuration of the control unit 100 may be provided in the home servers 12A and 12B and the remaining configuration of the control unit 100 may be provided in the input/output units 11A and 11B.

As described above, according to the present technology, the state of the user, the context, the relative relationship with the partner user, and the like are analyzed using the data to be analyzed such as sensor data based on the human visual characteristics, and the shape of the display region (effective region) of the display device is controlled based on the result of analysis.

As a result, during communication between users at remote locations through a video communication system (telepresence system), more natural communication can be provided.

Further, the telepresence system to improve the quality of relationships with remote locations can make the user feel the space and the partner user more naturally without the sense of invasion of privacy and excessive oriented purpose, and provide appropriate co-creation activities. In addition, since the shape of the display region is changed according to the state of the user, a natural and comfortable feeling of continuous connection can be obtained.

In addition, it is possible to change the user's consciousness and the way of communication from the environment side of the system. Furthermore, as compared to environments such as VR (Virtual Reality) where it is necessary to wear a special device such as a head-mounted display on the head in order for users to communicate with each other using a telepresence device with a display, the users can communicate more naturally with each other.

Further, according to the present technology, since the state of the space of the partner can be presented in the ineffective region serving as a mask region, the user can recognize not only the video displayed in the effective region but also the state of the space of the partner presented in the ineffective region, so that the user can grasp the situation of the space of the partner at a remote location more deeply.

### 3. CONFIGURATION OF COMPUTER

The above-described series of processing of the information processing device 10 can also be performed by hardware or software. In the case where the series of processing is executed by software, a program that configures the software is installed on a computer of each device.

The program to be executed by the computer (CPU) can be recorded on, for example, a removable recording medium (for example, a magnetic disk, an optical disk, a magneto-optical disk, a semiconductor memory, or the like), which serves as a package medium for supply. The program can be supplied via a wired or wireless transmission medium such as a local area network, the Internet, or digital satellite broadcasting.

In the computer, by loading the removable recording medium into a drive, the program can be installed in the storage unit via an input/output interface. The program can be received by a communication unit via the wired or wireless transmission medium and installed in the storage unit. In addition, the program can be installed in advance in the ROM or the storage unit.

Here, in the present specification, the processing performed by the computer in accordance with the program may not necessarily be performed chronologically in the order described in the flowchart. That is, the processing performed by the computer in accordance with the program also includes processing which is performed individually or in parallel (for example, parallel processing or processing by an object).

The program may be a program processed by one computer (processor) or may be distributed over and processed by a plurality of computers. Further, the program may be transmitted to a remote computer and executed there.

In addition, in the present specification, a system means a collection of a plurality of constituent elements (devices, modules (components), or the like) and whether all the constituent elements are contained in the same casing does not matter. Accordingly, a plurality of devices accommodated in separate casings and connected via a network and one device in which a plurality of modules are accommodated in one casing are all systems.

Note that embodiments of the present technology are not limited to the above-described embodiments and various modifications can be made within the scope of the present technology without departing from the gist of the present technology. For example, the present technology can be configured as cloud computing in which one function is shared and processed in common by a plurality of devices via a network.

In addition, the respective steps of the above-described flowcharts can be executed by one device or in a shared manner by a plurality of devices. Furthermore, in a case where a plurality of kinds of processing are included in a single step, the plurality of kinds of processing included in the single step can be executed by one device or by a plurality of devices in a shared manner.

The advantageous effects described in the present specification are merely exemplary and are not limited, and other advantageous effects may be achieved.

Note that the present technology may also have the following configurations.

(1) An information processing device including a control unit, wherein, between a first space where a first imaging device and a first display device are installed and a second space where a second imaging device and a second display device are installed, when a captured image captured by the imaging device in one of the spaces is displayed by the display device in the other space in real time,

the control unit performs a control for presenting a state of the second space in an ineffective region excluding an effective region in which a captured image captured by the second imaging device is displayed, in a display region of the first display device.

(2) The information processing device according to (1), wherein

the control unit presents the state of the second space so as to make a first user in the first space feel the state of the second space by at least one of sensory functions of visual, auditory, and haptic senses.

(3) The information processing device according to (1) or (2), wherein

the control unit presents the state of the second space in all or part of the ineffective region corresponding to the state of the second space.

(4) The information processing device according to any one of (1) to (3), wherein

the control unit presents complementary information of the captured image displayed in the effective region as the state of the second space.

(5) The information processing device according to any one of (1) to (3), wherein

the control unit presents information having no direct relation with the captured image displayed in the effective region as the state of the second space.

(6) The information processing device according to any one of (1) to (3), wherein the control unit

analyzes, based on human visual field characteristics, a state of a first user in the first space by using data to be analyzed, and

presents the state of the second space in the ineffective region based on a result of analyzing the state of the first user.

(7) The information processing device according to (6), wherein

the visual field characteristics include a discrimination visual field, an effective visual field, and a stable visual fixation field, and

the control unit presents the state of the second space in a region corresponding to the stable visual fixation field in the ineffective region.

(8) The information processing device according to (6) or (7), wherein

the control unit acquires data obtained from a device installed in at least one of the first space and the second space as the data to be analyzed.

(9) The information processing device according to any one of (6) to (8), wherein the control unit controls a shape of the effective region in the display region of the first display device based on the result of analyzing the state of the first user.

(10) The information processing device according to any one of (1) to (9), wherein the control unit presents, according to a degree of activity of communication between a first user in the first space and a second user in the second space, a state of the second user.

(11) The information processing device according to (10), wherein

the control unit vibrates the ineffective region according to the degree of activity of communication.

(12) The information processing device according to any one of (1) to (9), wherein the control unit presents the state of the second space based on environmental information on the second space.

(13) The information processing device according to (12), wherein

the environmental information includes information on weather or earthquake, and the control unit vibrates the ineffective region according to a degree of the weather or earthquake.

(14) The information processing device according to any one of (1) to (9), wherein the control unit presents the state of the second space based on out-of-angle information on outside of an angle of view of the second imaging device.

(15) The information processing device according to (14), wherein

the out-of-angle information includes information on a sign or sound of an object, and

the control unit vibrates the ineffective region according to a degree of the sign or sound of the object.

(16) The information processing device according to (14), wherein

the out-of-angle information includes information on a sound of an object, and

the control unit visually changes the ineffective region according to a degree of the sound of the object.

(17) The information processing device according to any one of (1) to (9), wherein the control unit visually changes the ineffective region according to a situation of communication between a plurality of second users in the second space.

(18) The information processing device according to any one of (1) to (17), wherein a shape of the effective region in the display region includes any one of a rectangle, a circle, ellipse, a polygon, and a predetermined symbol shape.

(19) The information processing device according to any one of (1) to (18), wherein the information processing device is configured integrally with the first imaging device and the first display device which are installed in the first space, and is connected via a network to another information processing device configured integrally with the second imaging device and the second display device which are installed in the second space.

(20) An information processing method of causing an information processing device to perform:

between a first space where a first imaging device and a first display device are installed and a second space where a second imaging device and a second display device are installed, when a captured image captured by the imaging device in one of the spaces is displayed by the display device in the other space in real time,

a control for presenting a state of the second space in an ineffective region excluding an effective region in which a captured image captured by the second imaging device is displayed, in a display region of the first display device.

### REFERENCE SIGNS LIST

1 Information processing system

10, 10A, 10B Information processing device

11A, 11B Input/output unit

12A, 12B Home server

20 Server

50 Network

100 Control unit

101 CPU

102 ROM

103 RAM

104 Bus

105 Input/output I/F

106 Input unit

107 Output unit

108 Storage unit

109 Communication unit

111 Operation unit

112 Camera unit

113 Sound collection unit

114 Sensor unit

121 Display unit

122 Sound output unit

131 Data acquisition unit

132 Analysis processing unit

133 Presentation control unit

151 Display region

161 Effective region

162 Ineffective region

1. An information processing device comprising a control unit, wherein, between a first space where a first imaging device and a first display device are installed and a second space where a second imaging device and a second display device are installed, when a captured image captured by the imaging device in one of the spaces is displayed by the display device in the other space in real time,
the control unit performs a control for presenting a state of the second space in an ineffective region excluding an effective region in which a captured image captured by the second imaging device is displayed, in a display region of the first display device.

2. The information processing device according to claim 1, wherein
the control unit presents the state of the second space so as to make a first user in the first space feel the state of the second space by at least one of sensory functions of visual, auditory, and haptic senses.

3. The information processing device according to claim 2, wherein
the control unit presents the state of the second space in all or part of the ineffective region corresponding to the state of the second space.

4. The information processing device according to claim 3, wherein
the control unit presents complementary information of the captured image displayed in the effective region as the state of the second space.

5. The information processing device according to claim 3, wherein
the control unit presents information having no direct relation with the captured image displayed in the effective region as the state of the second space.

6. The information processing device according to claim 3, wherein the control unit analyzes, based on human visual field characteristics, a state of a first user in the first space by using data to be analyzed, and
presents the state of the second space in the ineffective region based on a result of analyzing the state of the first user.

7. The information processing device according to claim 6, wherein
the visual field characteristics include a discrimination visual field, an effective visual field, and a stable visual fixation field, and
the control unit presents the state of the second space in a region corresponding to the stable visual fixation field in the ineffective region.

8. The information processing device according to claim 6, wherein
the control unit acquires data obtained from a device installed in at least one of the first space and the second space as the data to be analyzed.

9. The information processing device according to claim 6, wherein
the control unit controls a shape of the effective region in the display region of the first display device based on the result of analyzing the state of the first user.

10. The information processing device according to claim 3, wherein
the control unit presents, according to a degree of activity of communication between a first user in the first space and a second user in the second space, a state of the second user.

11. The information processing device according to claim 10, wherein
the control unit vibrates the ineffective region according to the degree of activity of communication.

12. The information processing device according to claim 3, wherein
the control unit presents the state of the second space based on environmental information on the second space.

13. The information processing device according to claim 12, wherein
the environmental information includes information on weather or earthquake, and the control unit vibrates the ineffective region according to a degree of the weather or earthquake.

14. The information processing device according to claim 3, wherein
the control unit presents the state of the second space based on out-of-angle information on outside of an angle of view of the second imaging device.

15. The information processing device according to claim 14, wherein
the out-of-angle information includes information on a sign or sound of an object, and
the control unit vibrates the ineffective region according to a degree of the sign or sound of the object.

16. The information processing device according to claim 14, wherein
the out-of-angle information includes information on a sound of an object, and the control unit visually changes the ineffective region according to a degree of the sound of the object.

17. The information processing device according to claim 3, wherein
the control unit visually changes the ineffective region according to a situation of communication between a plurality of second users in the second space.

18. The information processing device according to claim 1, wherein
a shape of the effective region in the display region includes any one of a rectangle, a circle, ellipse, a polygon, and a predetermined symbol shape.

19. The information processing device according to claim 1, wherein
the information processing device is configured integrally with the first imaging device and the first display device which are installed in the first space, and is connected via a network to another information processing device configured integrally with the second imaging device and the second display device which are installed in the second space.

20. An information processing method of causing an information processing device to perform:
between a first space where a first imaging device and a first display device are installed and a second space where a second imaging device and a second display device are installed, when a captured image captured by the imaging device in one of the spaces is displayed by the display device in the other space in real time,
a control for presenting a state of the second space in an ineffective region excluding an effective region in which a captured image captured by the second imaging device is displayed, in a display region of the first display device.
